(19) United States
(12) Patent Application Publication
(10) Pub. No.: US 2026/0169144 A1
(43) Pub. Date: Jun. 18, 2026

(54) RADIO WAVE COMMUNICATION SYSTEM, CONTROL DEVICE THEREOF, AND CONTROL METHOD THEREOF

(71) Applicant: Bosch Engineering K.K., Kanagawa (JP)

(72) Inventors: Emilien Henry, Kanagawa (JP); Hiroshi Kawata, Kanagawa (JP); Karthik Natarajan, Kanagawa (JP); Susumu Yoshida, Kanagawa (JP)

(21) Appl. No.: 19/099,491

(22) PCT Filed: Jun. 19, 2023
(86) PCT No.: PCT/JP2023/022665

§ 371 Date: Jan. 29, 2025

(30) Foreign Application Priority Data
Jul. 29, 2022 (JP) 2022-121933

(51) Int. Cl. G01S 13/02; G01S 7/00; G01S 13/76; G01S 13/87; G01S 13/931

(52) U.S. Cl. CPC G01S 13/0209; G01S 7/006; G01S 13/765; G01S 13/878; G01S 13/931; G01S 2013/932; G01S 2013/93272

(57) ABSTRACT

Provided are a radio wave communication system for a vehicle capable of switching between communication control and radar control, a control device thereof, and a control method thereof. A radio wave communication system 100 mounted to an automobile 1 includes an acquisition unit 20a that acquires state information regarding a state of the automobile 1 and an execution unit 20b that controls communication devices 10a to 10h. The mode of a communication network includes a first mode PAN1 in which communication is performed between the communication devices 10a to 10h and a portable terminal (U), and a second mode PAN2 and a third mode PAN3 in which communication is performed between the communication devices of the of communication devices 10a to 10h. The execution unit 20b performs a control of switching the mode of the communication network based on the state information, executes a locking/unlocking process Sc in a state in which the first mode PAN1 is formed, and executes a radar process Sd in a state in which the second mode PAN2 and the third mode PAN3 are formed.

### BACKGROUND

The present invention relates to a radio wave communication system which is mounted in a vehicle and performs communication by radio waves, a control device thereof, and a control method thereof.

In the related art, known technologies using ultra-wideband (UWB) radio waves include a keyless entry system in which a communication device mounted to a vehicle and a portable terminal located in the periphery of the vehicle communicate with each other by using UWB radio waves and a lock provided to the vehicle is controlled to be locked or unlocked based on the communication (for example, see JP 2022-83289 A). In addition, for example, a known radar device transmits UWB radio waves around a vehicle, receives reflected waves reflected by an object, and detects the object around the vehicle based on the reflected waves (for example, see JP 2022-83289 A).

In the technologies described in JP 2022-83289 A and JP 2013-83540 A, for example, when the keyless entry system and the radar device are installed as separate devices in the same vehicle, communication devices and control devices that transmit and receive UWB radio waves are duplicately installed, and thus the space inside the vehicle may be reduced or radio waves interfere with each other.

### SUMMARY

The invention has been made against the background of the above-described problems, and an object thereof is to provide a radio wave communication system for a vehicle, a control device thereof, and a control method thereof capable of executing a communication control and a radar control in a switchable manner.

A control device for a radio wave communication system according to the invention is a control device (20) for a radio wave communication system (100) mounted to an automobile (1) as a vehicle and including a plurality of communication devices (10a to 10h) that forms a communication network by radio waves to communicate with a portable terminal (U). The control device (20) includes an acquisition unit (20a) that acquires state information regarding a state of the automobile (1), and an execution unit (20b) that executes a control process of controlling the plurality of communication devices (10a to 10h). The mode of the communication network includes a first mode (PAN1) in which communication is performed between the plurality of communication devices (10a to 10h) and the portable terminal (U) and a second mode (PAN2, PAN3) in which communication is performed between the communication devices of the plurality of communication devices (10a to 10h). The control process includes a locking/unlocking process (Sc) (communication process) of performing a control such that the plurality of communication devices (10a to 10h) communicates with the portable terminal (U) and a radar process (Sd) of performing a control such that at least one communication device (10a, 10e) out of the plurality of communication devices (10a to 10h) emits radio waves and an object (O1, O2) located in a periphery of the automobile (1) is detected based on reflected waves generated when the radio waves are reflected by the object. The execution unit (20b) performs a control of switching the mode of the communication network based on the state information, executes the locking/unlocking process (Sc) (communication process) in a state in which the first mode (PAN1) is formed, and executes the radar process (Sd) in a state in which the second mode (PAN2, PAN3) is formed.

According to such a configuration, the control device (20) can switch, based on the state information, the modes of the communication network formed by the plurality of communication devices (10a to 10h) and the portable terminal (U) between the first mode (PAN1), the second mode (PAN2), and a third mode (PAN3), thereby operating the radio wave communication system (100) by switching between a radar system that detects the object using radio waves and a communication system that performs communication using radio waves in accordance with the state of the automobile (1). In the radar system and the communication system, the communication devices (10a to 10h) and the control device (20) can be used in common, and thus the installation space and the costs of the system can be reduced.

A radio wave communication system according to the invention is a radio wave communication system (100) mounted to an automobile (1) as a vehicle and including a plurality of communication devices (10a to 10h) that forms a communication network by radio waves to communicate with a portable terminal (U). The radio wave communication system (100) includes an acquisition unit (20a) that acquires state information regarding a state of the automobile (1), and an execution unit (20b) that executes a control process of controlling the plurality of communication devices (10a to 10h). The mode of the communication network includes a first mode (PAN1) in which communication is performed between the plurality of communication devices (10a to 10h) and the portable terminal (U) and a second mode (PAN2, PAN3) in which communication is performed between the communication devices of the plurality of communication devices (10a to 10h). The control process includes a locking/unlocking process (Sc) (communication process) of performing a control such that the plurality of communication devices (10a to 10h) communicates with the portable terminal (U) and a radar process (Sd) of performing a control such that at least one communication device (10a, 10e) out of the plurality of communication devices (10a to 10h) emits radio waves and an object (O1, O2) located in a periphery of the automobile (1) is detected based on reflected waves generated when the radio waves are reflected by the object. The execution unit (20b) performs a control of switching the mode of the communication network based on the state information, executes the locking/unlocking process (Sc) (communication process) in a state in which the first mode (PAN1) is formed, and executes the radar process (Sd) in a state in which the second mode (PAN2, PAN3) is formed.

According to such a configuration, the radio wave communication system (100) can switch, based on the state information, the mode of the communication network formed by the plurality of communication devices (10a to 10h) and the portable terminal (U) between the first mode (PAN1) and the second mode (PAN2, PAN3), thereby operating the radio wave communication system (100) by switching between a radar system that detects the object using radio waves and a communication system that performs communication using radio waves in accordance with the state of the automobile (1).

A control method for a radio wave communication system according to the invention is a control method for a radio wave communication system (100) mounted to an automobile (1) as a vehicle and including a plurality of communication devices (10a to 10h) that forms a communication network by radio waves to communicate with a portable terminal (U). The control method includes an acquisition step of acquiring state information regarding a state of the automobile (1) by an acquisition unit (20a), and an execution step of executing a control process of controlling the plurality of communication devices (10a to 10h) by an execution unit (20b). The mode of the communication network includes a first mode (PAN1) in which communication is performed between the plurality of communication devices (10a to 10h) and the portable terminal (U) and a second mode (PAN2, PAN3) in which communication is performed between the communication devices of the plurality of communication devices (10a to 10h). The control process includes a locking/unlocking process (Sc) (communication process) of performing a control such that the plurality of communication devices (10a to 10h) communicates with the portable terminal (U) and a radar process (Sd) of performing a control such that at least one communication device (10a, 10e) out of the plurality of communication devices (10a to 10h) emits radio waves and an object (O1, O2) located in a periphery of the automobile (1) is detected based on reflected waves generated when the radio waves are reflected by the object. In the execution step, the execution unit (20b) performs a control of switching the mode of the communication network based on the state information, executes the locking/unlocking process (Sc) (communication process) in a state in which the first mode (PAN1) is formed, and executes the radar process (Sd) in a state in which the second mode (PAN2, PAN3) is formed.

According to such a configuration, the mode of the communication network formed by the plurality of communication devices (10a to 10h) and the portable terminal (U) can be switched between the first mode (PAN1) and the second mode (PAN2, PAN3) based on the state information, whereby the radio wave communication system (100) can be operated by being switched between a radar system that detects the object using radio waves and a communication system that performs communication using radio waves in accordance with the state of the automobile (1).

It should be noted that the invention may include only the matters used to specify the invention described in the claims of the invention, or may include a configuration other than the matters used to specify the invention described in the claims of the invention in addition to the matters used to specify the invention.

### BRIEF DESCRIPTION OF THE DRAWINGS

FIG. 1 is a diagram for explaining a configuration of a radio wave communication system in an embodiment.

FIG. 2 is a diagram for explaining an arrangement of communication devices and absorbers.

FIG. 3 is a diagram for explaining a configuration of a control device.

FIG. 4 is a diagram for explaining a first mode of a communication network.

FIG. 5 is a diagram for explaining a second mode and a third mode of the communication network.

FIG. 6 is a diagram for explaining a flow of controlling a switching process executed by the control device.

FIG. 7 is a diagram for explaining a flow of controlling a terminal-side positioning process executed by the control device.

FIG. 8 is a diagram for explaining a flow of controlling a locking/unlocking process executed by the control device.

FIG. 9 is a diagram for explaining a flow of controlling a radar process executed by the control device.

FIG. 10 is a diagram for explaining information regarding reflected waves extracted based on an intensity threshold value and a distance threshold value in a filtering process.

FIG. 11 is a diagram for explaining information regarding reflected waves extracted based on changes in a distribution of radio wave intensities of received signals with respect to a reference value in a modification example of the filtering process.

### DETAILED DESCRIPTION

Hereinafter, examples of embodiments of a radio wave communication system, a control method for the radio wave communication system, and a control device for the radio wave communication system according to the invention will be described using the accompanying drawings. It should be noted that configurations, operations, and the like that will be described below are merely examples, and the invention is not limited to such configurations, operations, and the like. In the following, the same or similar descriptions are simplified or omitted as appropriate. For the same or similar members or parts in each drawing, assignment of reference signs is omitted or the same reference signs are assigned. In addition, details of structures and the like are appropriately simplified or omitted in the drawings.

The radio wave communication system, the control method, and the control device according to the present embodiment will be described by taking, as an example, a case in which they are applied to an automobile as a vehicle, but the invention is not particularly limited to being applied to an automobile, and can be applied to other mobile bodies such as a four-wheel vehicle, a motorcycle, or a bicycle, for example.

### Embodiment

### Wave Communication System and Control Device

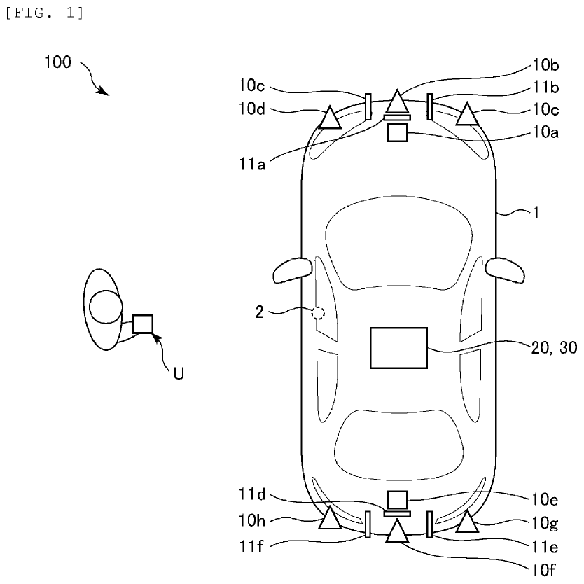

A radio wave communication system 100 according to the present embodiment will be described based on FIG. 1 to FIG. 5. The radio wave communication system 100 is a system that is mounted to an automobile 1 and transmits radio waves to a periphery of the automobile 1 to perform communication with a portable terminal U and detect an object in the periphery.

As illustrated in FIG. 1, the radio wave communication system 100 includes first to eighth communication devices 10a to 10h that transmit radio waves to perform wireless communication, a control device 20 that controls the radio wave communication system 100, and a portable terminal U that is carried and operated by a driver of the automobile 1 or the like and performs wireless communication with the first to eighth control devices 10a to 10h.

The first to eighth communication devices 10a to 10h are devices that perform communication by transmitting and receiving signals transferred by ultra-wideband (UWB) radio waves, and perform communication based on a UWB communication protocol of the IEEE802.15.4a/z standard. Communication devices conforming to the IEEE802.15.4a/z standard can implement a ranging function of measuring a distance between the communication devices in communication, based on, for example, a time difference of arrival (TDoA), a phase difference of arrival (PDoA), or two-way ranging (TWR). In the TWR, based on a required time TA for a predetermined process between one communication device and another communication device (for example, a process in which the one communication device transmits a predetermined notification to the other communication device, the other communication device waits for a predetermined time T0 after receiving the notification, and then transmits a reply notification), a time of flight ((TA-T0)/2) of a signal between these two communication devices or a distance between these two communication devices can be calculated. In the communication between these communication devices, since transmitted radio waves are reflected, diffracted, propagated in a plurality of paths, and received, the same signals may be repeatedly received at different arrival times due to differences in the distances of the paths, resulting in waveform disturbance or phase shift in the received signals (so-called multipath effect). However, the transmitted notification can be detected by processing the signals based on the time of flight of radio waves or the distance between the communication devices calculated as described above.

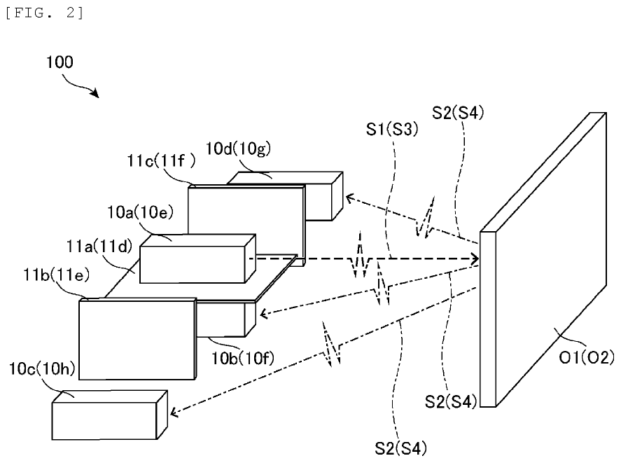

When viewed from above the automobile 1, the first communication device 10a and the second communication device 10b are installed, for example, at a center portion of a front bumper of the automobile 1, the third communication device 10c is installed at a left portion of the front bumper of the automobile 1, the fourth communication device 10d is installed at a right portion of the front bumper of the automobile 1, the fifth communication device 10e and the sixth communication device 10f are installed at a center portion of a rear bumper of the automobile 1, the seventh communication device 10g is installed at a left portion of the rear bumper of the automobile 1, and the eighth communication device 10h is installed at a right portion of the rear bumper of the automobile 1 (see FIG. 1). In addition, the first communication device 10a is disposed above the second communication device 10b, and the first to fourth communication devices 10a to 10d are disposed such that the transmission direction of radio waves is a forward direction of the automobile 1. The fifth communication device 10e is disposed above the sixth communication device 10f, and the fifth to eighth communication devices 10e to 10h are disposed such that the transmission direction of radio waves is a rearward direction of the automobile 1 (see FIG. 2). The first to fourth communication devices 10a to 10h may be collectively and simply referred to as the communication device 10.

The first communication device 10a and the fifth communication device 10e can wirelessly communicate with a plurality of communication devices set as communication targets by the control device 20 to be described below, and can communicate with one or a plurality of communication devices out of the first to eighth communication devices 10a to 10h and the portable terminal U. These first and fifth communication devices 10a and 10e are provided with, for example, a full function device (FFD) defined by the IEEE802.15.4a/z standard, implemented with a full protocol set, and capable of functioning as network coordinators and performing communication between the FFDs and communication with an RFD to be described below. The network coordinator is a device that starts network connection, and only one network coordinator can be present in one network.

The second communication device 10b, the third communication device 10c, the fourth communication device 10d, the sixth communication device 10f, the seventh communication device 10g, and the eighth communication device 10g can communicate with one communication device set as a communication target by the control device 20, and can communicate with only one communication device out of the first communication device 10a, the fifth communication device 10e, and the portable terminal U. These communication devices 10b, 10c, 10e, and 10f are, for example, communication devices that are provided with a reduced function device (RFD) defined by the IEEE802.15.4a/z standard, implemented with a minimum protocol set limited by a star topology, and capable of communicating with only a network coordinator.

A communication device which is a communication target of each of the first to eighth communication devices 10a to 10h can be switched under the control of the control device 20.

As illustrated in FIG. 1 and FIG. 2, first to sixth absorbers 11a to 11f that absorb radio waves transmitted by the communication devices are disposed to positions between the first communication device 10a and the second to fourth communication devices 10b to 10d, and positions between the fifth communication device 10e and the sixth to eighth communication devices 10f to 10h.

The first absorber 11a having a planar shape extending in the horizontal direction is disposed to a position between the first communication device 10a and the second communication device 10b, the second absorber 11b having a planar shape extending in the vertical direction is disposed to a position between the first communication device 10a and the third communication device 10c, and the third absorber 11c having a planar shape extending in the vertical direction is disposed to a position between the first communication device 10a and the fourth communication device 10d (see FIG. 2). Accordingly, the first communication device 10a is disposed in a space partitioned by the first to third absorbers 11a to 11c, and thus direct entry of a radio wave S1 transmitted from the first communication device 10a to the second to fourth communication devices 10b to 10d is reduced, and entry of reflected waves, which are generated when the radio wave transmitted from the first communication device 10a are reflected inside the automobile 1, to the second to fourth communication devices 10b to 10d is reduced. As a result, a reflected wave S2 generated due to reflection by an object O1 outside the automobile 1 easily enters the second to fourth communication device 10b to 10d.

The fourth absorber 11d having a planar shape extending in the horizontal direction is disposed to a position between the fifth communication device 10e and the sixth communication device 10f, the fifth absorber 11e having a planar shape extending in the vertical direction is disposed to a position between the fifth communication device 10e and the seventh communication device 10g, and the sixth absorber 11f having a planar shape extending in the vertical direction is disposed to a position between the fifth communication device 10e and the eighth communication device 10h (see FIG. 2). Accordingly, the fifth communication device 10e is disposed in a space partitioned by the fourth to sixth absorbers 11d to 11f, and thus direct entry of a radio wave S3 transmitted from the fifth communication device 10e to the sixth to eighth communication devices 10f to 10h is reduced, and entry of reflected waves, which are generated when the radio wave transmitted from the fifth communication device 10e are reflected inside the automobile 1, to the sixth to eighth communication devices 10f to 10h is reduced. As a result, a reflected wave S4 generated due to reflection by an object O2 outside the automobile 1 easily enters the sixth to eighth communication device 10f to 10h.

The portable terminal U is a small portable electronic device (for example, a smartphone) that can be held by a driver or the like of the automobile 1, and can wirelessly communicate with the first to eighth communication devices 10a to 10h by radio waves. In addition, the portable terminal U has a function of receiving operations by the driver or the like, and includes, for example, a lock button to receive a locking operation for locking a lock 2 provided to a door of the automobile 1 and an unlock button to receive an unlocking operation for unlocking the lock 2 (not illustrated). When the locking operation or the unlocking operation is received, for example, a locking/unlocking signal including operation information Ip regarding the corresponding operation can be transmitted to the radio wave communication system 100 of the automobile 1 by radio waves. In addition, the portable terminal U is provided with, for example, a full function device (FFD) defined by the IEEE802.15.4a/z standard, and can communicate with the above-described FFDs and RFDs of the first to eighth communication devices 10a to 10h.

As a means for receiving operations, the portable terminal U may be configured with, for example, a button switch or a touch display, or may be configured to receive operations using a voice recognition technology, a gesture recognition technology, or the like. In addition, the portable terminal U only needs to have a function of communicating with the radio wave communication system 100 by radio waves, and may be, for example, a mobile phone, a smartphone, or a tablet PC, or many be configured with a general-purpose information processing device that transmits and receives radio waves, or may be configured with a dedicated device such as a remote control key.

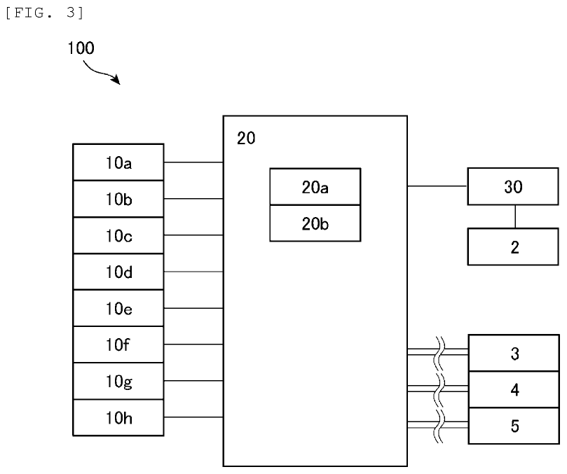

As illustrated in FIG. 3, the control device 20 includes an acquisition unit 20a that acquires various information and an execution unit 20b that executes various control processes. The control device 20 is configured with an electronic circuit or the like (not illustrated) including a central processing unit (CPU), a read-only memory (ROM), a random access memory (RAM), or the like, and operates by being supplied with electric power from a battery or the like (not illustrated) provided to the automobile 1. Various programs stored in a storage device such as the ROM are executed by the CPU, whereby functions of executing various control processes to be described below are implemented by the acquisition unit 20a and the execution unit 20b. It should be noted that the control device 20 may be configured with dedicated hardware resources and dedicated software resources, or may be configured with common hardware resources and common software resources included in devices which are mounted to the automobile 1 and execute other controls. In addition, at least part of functions of the control device 20 may be configured with hardware resources and software resources outside the automobile 1 connected via a network or the like.

The control device 20 is electrically connected to the first to eighth communication devices 10a to 10h, and can control each of the communication devices by performing wired communication with the communication devices via signal lines. In addition, the control device 20 is electrically connected via a signal line to a locking/unlocking device 30 that locks and unlocks the lock 2 provided to the automobile 1, and can control the locking/unlocking device 30 as will be described below. In addition, the control device 20 is electrically connected to an in-vehicle network controller area network (CAN) to which various sensors, other control devices, and the like (not illustrated) provided to the automobile 1 are connected, and can acquire, for example, vehicle speed information Iv regarding a travel speed of the automobile 1 detected by a vehicle speed sensor 3, seating information Is regarding whether it is a seating state in which a driver's seat is occupied detected by a seat sensor 4 of the driver's seat, and start information Ig regarding an ON-OFF state (power start state) of a power start switch (a so-called ignition switch) of the automobile 1 detected by an ignition switch sensor 5, via the in-vehicle network CAN. The control device 20 may include various sensors such as a vehicle speed sensor.

The control device 20 can control and switch the mode of a communication network personal area network (PAN) formed by the first to eighth communication devices 10a to 10h and the portable terminal U by transmitting control signals to the first to eighth communication devices 10a to 10h and the portable terminal U. The mode of the communication network formed by the first to eighth communication devices 10a to 10h and the portable terminal U include, for example, a first mode PANI in which communication is performed between the first to eighth communication devices 10a to 10h and the portable terminal U, a second mode PAN2 in which communication is performed between the communication devices disposed on the front side of the automobile 1 out of the first to eighth communication devices 10a to 10h, and a third mode PAN3 in which communication is performed between the communication devices disposed on the rear side of the automobile 1 out of the first to eighth communication devices 10a to 10h.

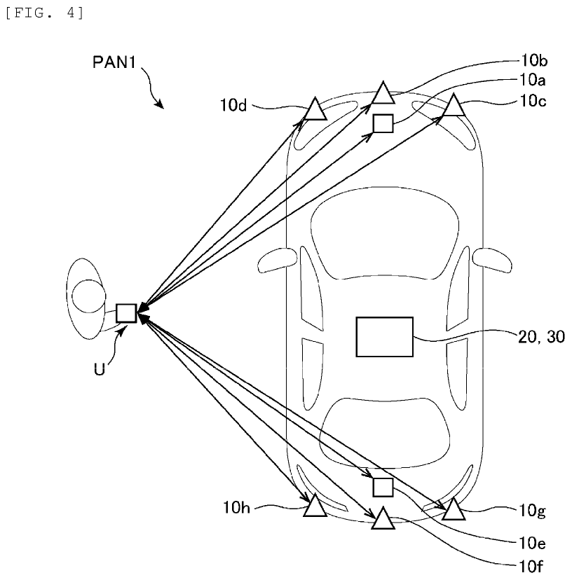

As illustrated in FIG. 4, in the first mode PAN1 of the communication network, the portable terminal U functions as a central hub, and the first to eighth communication devices 10a to 10h are not connected to each other, and each of the first to eighth communication devices 10a to 10h is connected to the portable terminal U. For example, the portable terminal U provided with an FFD according to IEEE802.15.4a/z standard functions as a network coordinator (PAN coordinator), and a communication network in which each of the first to eighth communication devices 10a to 10h is connected to the portable terminal U by a so-called star topology is formed, whereby wireless communication is performed between each communication device of the first to eighth communication devices 10a to 10h and the portable terminal U respectively.

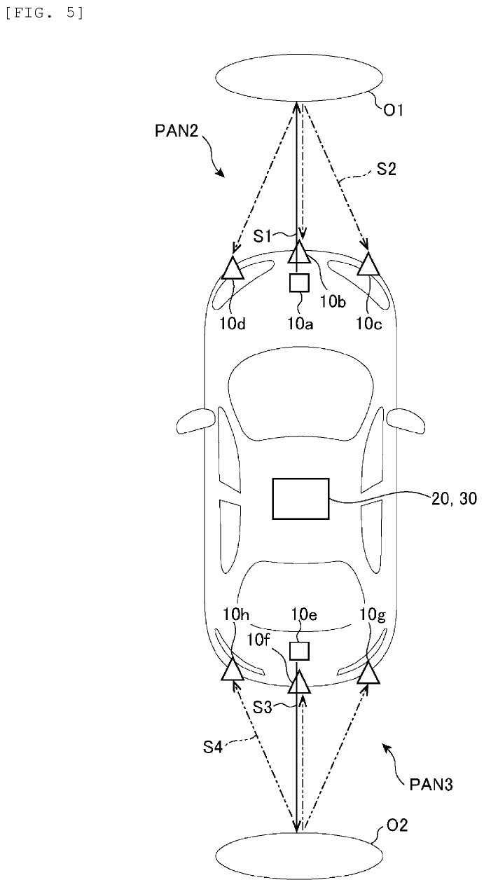

As illustrated in FIG. 5, in the second mode PAN2 of the communication network, the portable terminal U is not connected to the first to eighth communication devices 10a to 10h, and the first to fourth communication devices 10a to 10d configured to transmit radio waves to the forward direction of the automobile 1 are connected with the first communication device 10a as a central hub. For example, the first communication device 10a provided with an FFD according to IEEE802.15.4a/z standard functions as a network coordinator, and a communication network in which the second to fourth communication devices 10b to 10d are connected to the first communication device 10a by a so-called star topology is formed, whereby wireless communication is performed between each communication device of the second to fourth communication devices 10b to 10d and the first communication device 10a respectively. In the wireless communication between each communication device of the second to fourth communication devices 10b to 10d and the first communication device 10a, the radio wave S1 is emitted from the first communication device 10a in the forward direction of the automobile 1, a part of the emitted radio wave S1 is reflected by the object O1 to generate reflected waves S2, and a part of the reflected waves S2 is returned to the communication device side and received by the second to fourth communication devices 10b to 10d. A part of the radio wave S1 emitted from the first communication device 10a may not be reflected, and may be received directly by the second to fourth communication devices 10b to 10d.

In addition, as illustrated in FIG. 5, in the third mode PAN3 of the communication network, the portable terminal U is not connected to the first to eighth communication devices 10a to 10h, and the fifth to eighth communication devices 10e to 10h configured to transmit radio waves to the rearward direction of the automobile 1 are connected with the fifth communication device 10e as a central hub. For example, the fifth communication device 10e provided with an FFD according to IEEE802.15.4a/z standard functions as a network coordinator, and a communication network in which the sixth to eighth communication devices 10f to 10h are connected to the fifth communication device 10e by a so-called star topology is formed, whereby wireless communication is performed between each communication device of the sixth communication devices 10f to 10h and the fifth communication device 10e respectively. In the wireless communication between each communication device of the sixth to eighth communication devices 10f to 10h and the fifth communication device 10e, the radio wave S3 is emitted from the fifth communication device 10e in the rearward direction of the automobile 1, a part of the emitted radio wave S3 is reflected by the object O2 to generate reflected waves S4, and a part of the reflected waves S4 is returned to the communication device side and received by the sixth to eighth communication devices 10f to 10h. A part of the radio wave S3 emitted from the fifth communication device 10e may not be reflected, and may be received directly by the sixth to eighth communication devices 10f to 10h.

The acquisition unit 20a of the control device 20 acquires signal information Isg regarding signals transmitted and received by each of the first to eighth communication devices 10a to 10h, the vehicle speed information Iv regarding the travel speed of the automobile 1, the seating information Ist regarding the seating state of the driver's seat, and the start information Ig regarding the ON-OFF state of the power start switch (so-called ignition switch) of the automobile 1, and outputs the same to the execution unit 20b. In addition, the acquisition unit 20a can acquire other information as appropriate for the control processes in the control device 20.

The execution unit 20b can execute various control processes, and the control processes include a switching process, a terminal positioning process, a locking/unlocking process, and a radar process, for example. The switching process is a process of switching the mode of the communication network based on a state regarding the automobile 1 and the portable terminal U, and executing the locking/unlocking process, the radar process, or the like. The terminal positioning process is a process of acquiring distances between the first to eighth communication devices 10a to 10h and the portable terminal U based on the communication between the first to eighth communication devices 10a to 10h and the portable terminal U. The locking/unlocking process includes a process of communicating with the portable terminal U, and is a process of locking or unlocking the lock 2 by controlling the locking/unlocking device 30 based on the communication result. The radar process is a process in which the mode of the communication network is set to the second mode and the third mode, the first to eighth communication devices 10a to 10h are controlled to communicate with each other, the radio waves S1 and S3 are transmitted to the periphery of the automobile 1, and the reflected waves S2 and S4 are received, whereby objects are detected based on the reflected waves. These control processes will be described in detail below.

The locking/unlocking device 30 is provided with an actuator that operates to lock or unlock the lock 2 of the automobile 1, and the operation of the actuator is controlled based on a control signal transmitted from the control device 20. The lock 2 is unlocked when an unlocking instruction signal for unlocking the lock 2 is received, and the lock 2 is locked when a locking instruction signal for locking the lock 2 is received.

As described above, the radio wave communication system 100 of the present embodiment includes the first to eighth communication devices 10a to 10h and the control device 20. The control device 20 is configured to communicate with the portable terminal U by the first to eighth communication devices 10a to 10h, to lock and unlock the lock 2 at a door of the automobile 1 by controlling the locking/unlocking device 30 based on the communication results between the first to eighth communication devices 10a to 10h and the portable terminal U, and to control the first to eighth communication devices 10a to 10h to communicate with each other, thereby detecting an object around the automobile 1 based on reflected waves received.

In the present embodiment, the radio wave communication system 100 includes the first to eighth communication devices 10a to 10h, but the number and the installation positions of the communication devices, the transmission direction of radio waves, and the like are not limited to the above examples. For example, the radio wave communication system 100 may include the communication devices whose number and installation positions are determined based on the shape or the size of the automobile 1, the intensity or the transmission direction of radio waves transmitted from the communication devices, or the like. In addition, the number, the installation positions, the shapes, or the like of the absorbers can be determined based on the number and the installation positions of the communication devices. In the present embodiment, the first to eighth communication devices 10a to 10h are configured to emit radio waves to the front and rear of the automobile 1, but may include a communication device that emits radio waves to a side of the automobile 1, for example.

In the present embodiment, the lock 2 controlled to be locked and unlocked by the locking/unlocking device 30 is provided to a door of the automobile 1, but may be provided to a location other than a door of the automobile 1. For example, a configuration in which a lock is provided to a trunk room of the automobile 1, a configuration in which a lock is provided to a fuel port of the automobile 1, or a combination of these configurations are conceivable.

### Control Method for Radio Wave Communication System

As a method for controlling the radio wave communication system 100 according to the present embodiment, flows of controls in a switching process Sa, a terminal positioning process Sb, a locking/unlocking process Sc, and a radar process Sd executed by the control device 20 will be described based on FIG. 6 to FIG. 10. The switching process Sa is a process that is executed repeatedly at a predetermined time interval (e.g., every 0.01 seconds).

As illustrated in FIG. 6, in the switching process Sa, an information acquisition process is first executed to cause the acquisition unit 20a to acquire various information (Sa01). As the various information, the vehicle speed information Iv regarding the travel speed of the automobile 1 detected by the vehicle speed sensor 3, the seating information Ist regarding the seating state of the driver's seat detected by the seat sensor 4 of the driver's seat, and the start information Ig regarding the ON-OFF state of the power start switch (so-called ignition switch) of the automobile 1 detected by the ignition switch sensor 5 are acquired.

Then, based on the vehicle speed information Iv, it is determined whether a travel speed v of the automobile 1 exceeds a predetermined vehicle speed threshold value Tv (for example, a value determined based on a reachable distance of radio waves of the first to eighth communication devices 10a to 10h, and is set to 10 km/h or the like) (Sa02). When it is determined that the travel speed v exceeds the vehicle speed threshold value Tv (Y), a high-speed travel state flag indicating that the automobile 1 is in a state of traveling at a high speed exceeding the vehicle speed threshold value Tv is stored in a storage region (e.g., the RAM) of the control device 20 (Sa10). On the other hand, when it is determined that the travel speed v does not exceed the vehicle speed threshold value Tv (N), it is determined whether a start switch (illustration omitted) for starting the power of the automobile 1 is in an ON state based on the start information Ig (Sa03). When it is determined that the start switch is in the ON state (Y), a low-speed travel state flag indicating that the automobile 1 is in a state of traveling at a low speed not exceeding the vehicle speed threshold value Tv is stored in the storage region of the control device 20 (Sa11). On the other hand, when it is determined that the start switch is not in the ON state (N), it is determined whether the automobile 1 is in a state in which the driver is seated on the driver's seat based on the seating information Ist (Sa04). When it is determined to be in the state in which the driver is seated (Y), a vehicle stop state flag indicating that the automobile 1 is not traveling and in a stop state is stored in the storage region of the control device 20 (Sa12).

When it is determined to be not in the state in which the driver is seated in the step of Sa04 (N), the terminal positioning process Sb of measuring a current distance Ld from the radio wave communication system 100 to the portable terminal U is executed as will be described below (Sa05). Then, distance information Id regarding the current distance Ld between the radio wave communication system 100 and the portable terminal U generated by the terminal positioning process Sb is acquired by the acquisition unit 20a, and it is determined whether the automobile 1 is in a state of being located within a predetermined distance from the portable terminal U based on the distance information Id (Sa06). Specifically, the current distance Ld is compared with a predetermined distance threshold value T1 (for example, a value determined based on a reachable distance of radio waves of the communication devices 10, and is set to 20 m, or the like), and determined whether to be less than the distance threshold value T1 (Sa06). When it is determined that the current distance Ld to the portable terminal U is less than the distance threshold value T1 (Y), the automobile 1 is in a parked state and the portable terminal U is present around the automobile 1 (for example, within a range up to the distance threshold value T1), and an operation waiting state flag indicating waiting for a locking or unlocking operation by the portable terminal U is stored in the storage region of the control device 20 (Sa13). On the other hand, when it is determined that the current distance Ld to the portable terminal U is not less than the distance threshold value T1 (N), the automobile 1 is in a parked state and the portable terminal U is not present around the automobile 1, and a standby state flag indicating that the radio wave communication system 100 is controlled to be in a standby state is stored in the storage region of the control device 20 (Sa07).

After the high-speed travel state flag, the low-speed travel state flag, the vehicle stop state flag, the operation waiting state flag, or the standby state flag is stored in the storage region of the control device 20 (Sa10, Sa11, Sa12, Sa13, Sa07) based on the state of the automobile 1 or the portable terminal U, a communication network switching process of setting and switching a mode of the communication network based on the stored flag is executed (Sa08).

In the communication network switching process, when the low-speed travel state flag is set, each of the first communication device 10a and the fifth communication device 10e mounted to the automobile 1 is set as a network coordinator, and the first to eighth communication devices 10a to 10h control to form the communication network of the second mode and the third mode. As a result, the communication network of the second mode PAN2 in which the second to fourth communication devices 10b to 10d are connected as end devices to the network started from the first communication device 10a functioning as a network coordinator is formed, and the communication network of the third mode PAN3 in which the sixth to eighth communication devices 10f to 10h are connected as end devices to the network started from the fifth communication device 10e functioning as a network coordinator is formed.

On the other hand, when the vehicle stop state flag or the operation waiting state flag is set, the portable terminal U is set as a network coordinator, and the first to eighth communication devices 10a to 10h and the portable terminal U control to form the communication network of the first mode. As a result, the communication network of the first mode PAN1 in which the first to eighth communication devices 10a to 10h are connected as end devices to the network started from the portable terminal U is formed.

Further, when the high-speed travel state flag or the standby state flag is set, none of the first to eighth communication devices 10a to 10h and the portable terminal U are set as a network coordinator. Thus, no communication network is formed by first to eighth communication devices 10a to 10h and the portable terminal U.

Then, a mode switching process of switching the operation mode of the radio wave communication system 100 based on the stored flag is executed. In the mode switching process, when the high-speed travel state flag is set, a stop mode in which the first to eighth communication devices 10a to 10h are controlled to be in a stop state is set, or when the standby state flag is set, a power saving mode in which the first to eighth communication devices 10a to 10h are controlled to be in a power saving state is set, and switching to each mode is executed. On the other hand, when the low-speed travel state flag is set, a radar mode is set and the radar process to be described below is executed. Further, when the vehicle stop state flag or the operation waiting state flag is set, a locking/unlocking mode is set and the locking/unlocking process to be described below is executed.

The switching process is ended when the step of Sa09 is completed. Subsequently, the control process based on the operation mode set in the step of Sa09 is executed.

As described above, in the switching process Sa of the present embodiment, the communication network formed by the portable terminal U and the first to eighth communication devices 10a to 10h is switched between the first to third modes based on information regarding the state of the automobile 1 and the state of the portable terminal U. In addition, based on the information, the locking/unlocking process including a communication process in which communication between the portable terminal U and the first to eighth communication devices 10a to 10h is performed, and the radar process of detecting an object in a periphery of the automobile 1 by transmitting radio waves from the first and fifth communication devices 10a and 10e to a periphery of the automobile 1 and receiving reflected waves generated due to reflection at the object by the first to eighth communication devices 10a to 10h are executed in a switchable manner, whereby the radar process including a function different from the communication can be executed by using in common the first to eighth communication devices 10a to 10h that communicate with the portable terminal U in the locking/unlocking process.

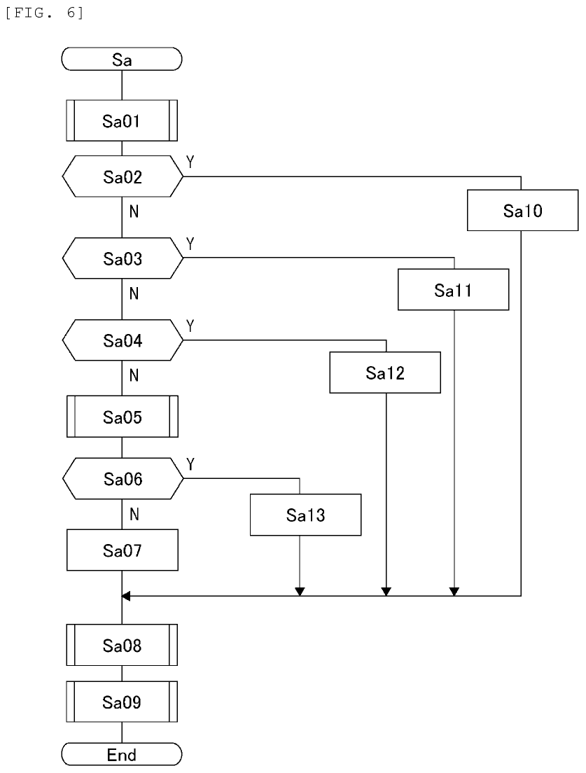

Next, the terminal positioning process Sb will be described based on FIG. 7. The terminal positioning process Sb is called and executed by the switching process described above.

As illustrated in FIG. 7, in the terminal positioning process Sb, a communication setting process is first executed (Sb01), so that the first to eighth communication devices 10a to 10h are controlled to form the communication network in the first mode PAN1. Then, after the communication network of the first mode PAN1 is formed, a positioning communication process is executed (Sb02), so that positioning signals are transmitted from the first communication device 10a and the fifth communication device to the portable terminal U, and transmission information regarding a time of transmission of the positioning signals is stored in the storage region of the control device 20. Then, reception of a return signal from the portable terminal U is waited, and upon reception of the return signal, reception information regarding a time of reception of the return signal is stored in the storage region of the control device 20.

After that, a distance calculation process is executed (Sb03) to calculate a time difference between the time of transmission of the positioning signals and the time of reception of the return signal based on the transmission information and the reception information acquired in the step of Sb2. Then, based on the time difference, the current distance Ld between the radio wave communication system 100 and the portable terminal U is calculated, the distance information Id regarding the current distance Ld is generated, and the terminal positioning process Sb is ended. The generated distance information Id is referred to in the switching process described above.

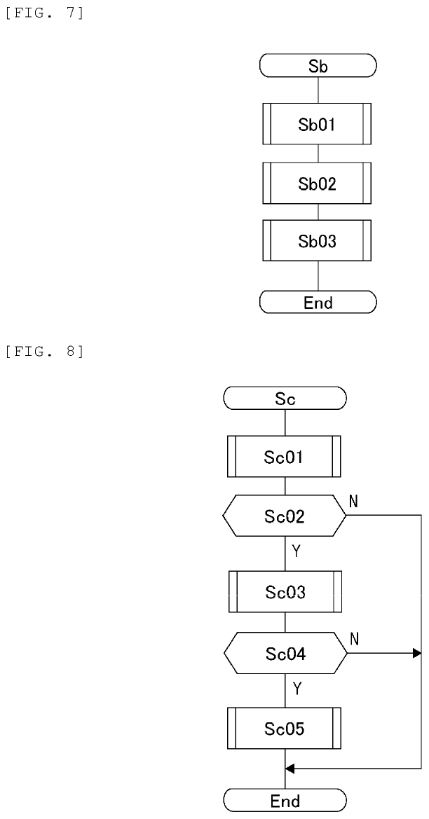

Next, the locking/unlocking process Sc will be described based on FIG. 8. The locking/unlocking process Sc is a process that is repeated at a predetermined time interval (for example, every 0.01 seconds) when any of the vehicle stop state flag or the operation waiting state flag is stored in the storage region of the control device 20 and the locking/unlocking mode is set by the switching process Sa described above.

As illustrated in FIG. 8, in the locking/unlocking process Sc, the above-described terminal positioning process Sb is first executed (Sc01) to acquire the current distance Ld from the radio wave communication system 100 (the automobile 1) to the portable terminal U and generate the distance information Id regarding the current distance Ld. Then, it is determined whether the current distance Ld is less than the predetermined distance threshold value T1 (for example, a value determined based on a reachable distance of radio waves of the communication devices 10, and is set to 20 m, or the like) (Sc02). When it is determined that the current distance Ld to the portable terminal U is less than the distance threshold value T1, that is, when the portable terminal U is within a predetermined range from the automobile 1 (Y), a communication waiting process is executed (Sc03). The communication waiting process waits until a communication signal from the portable terminal U is received by the first to eighth communication devices 10a to 10h. When a locking/unlocking signal including the operation information Ip regarding a locking operation or an unlocking operation in the portable terminal U is received as the communication signal, the operation information Ip included in the locking/unlocking signal is stored in the storage region of the control device 20.

Then, it is determined whether the locking/unlocking signal has been received (Sc04), and when the locking/unlocking signal has been received and the operation information Ip has been stored in the storage region of the control device 20 (Y), a locking/unlocking control process of controlling the operation of the locking/unlocking device 30 is executed (Sc05). In the locking/unlocking process, it is determined, based on the operation information Ip, whether a locking operation or an unlocking operation has been executed. When it is determined, based on the operation information Ip, that the locking operation has been executed, the operation of the locking/unlocking device 30 is controlled such that the lock 2 is locked. When it is determined, based on the operation information Ip, that the unlocking operation has been executed, the operation of the locking/unlocking device 30 is controlled such that the lock 2 is unlocked.

When it is determined in the step of Sc02 that the current distance Ld is not less that the predetermined distance threshold value T1 (N), or when it is determined in the step of Sc04 that the locking/unlocking signal has not been received (N), or when the locking/unlocking control process in the step Sc05 is ended, the locking/unlocking process Sc is ended in each case.

As described above, in the locking/unlocking process Sc of the present embodiment, communication between the portable terminal U and the first to eighth communication devices 10a to 10h is performed in the communication network of the first mode, and based on the operation information Ip regarding the locking operation or the unlocking operation included in the communication, the locking/unlocking device 30 is controlled such that the lock 2 is locked or unlocked. The locking/unlocking process of the present embodiment corresponds to the communication process of the invention.

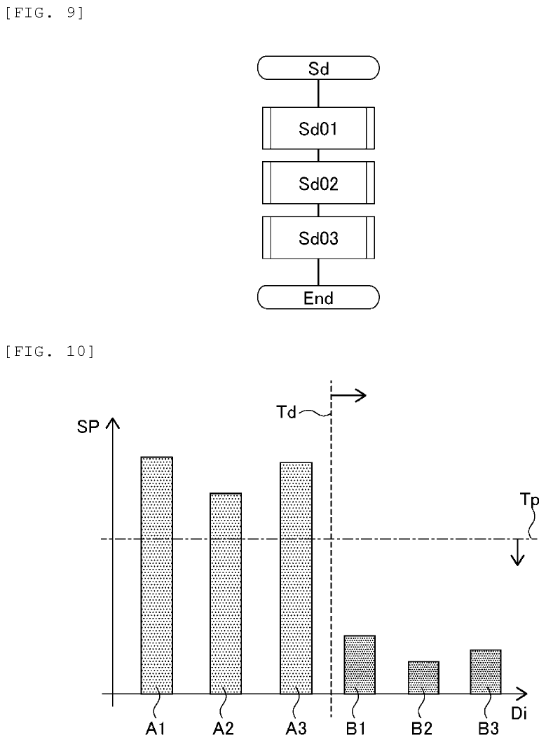

Next, the radar process Sd will be described based on FIG. 9. The radar process Sd is a process that is repeated at a predetermined time interval (for example, every 0.01 seconds) when the low-speed travel state flag is stored in the storage region of the control device 20 and the radar mode is set by the switching process Sa described above.

As illustrated in FIG. 9, in the radar process Sd, a search signal transmission and reception process in which a search signal for searching for an object around the automobile 1 is transmitted and received is first executed in a state in which the communication network of the second mode or the third mode is formed by the above-described switching process (Sd01). In the search signal transmission and reception process, search signals including identification information capable of identifying a time stamp and a signal regarding a transmission time are transmitted by radio waves from the first communication device 10a and the fifth communication device 10e which respectively operate as the network coordinators in the communication network of the second mode and the third mode to the periphery of the automobile 1. Then, the first to eighth communication devices 10a to 10h wait for a predetermined time in a state of being capable of receiving radio waves. During the predetermined time, a part of reflected waves generated when a part of the transmitted search signals is reflected by an object outside the automobile 1 is received by the first to eighth communication devices 10a to 10h. Then, the communication devices that have received the reflected waves store, in the storage regions thereof, time information regarding a time of reception of the reflected waves, the identification information included in the reflected waves, and intensity information regarding the intensities of radio waves of the received signals.

Then, a filtering process of extracting the information of the reflected waves received by the first to eighth communication devices 10a to 10h is executed (Sd02). In the filtering process, for example, for signals received by each of the communication devices 10a to 10h after the search signals are transmitted from the first communication device 10a and the fifth communication device 10e, radio wave intensities SP of the signals received are compared with a predetermined intensity threshold value Tp (for example, a value determined based on an experiment performed in advance, and is set as a value between radio wave intensity values in a case where the search signals transmitted from the first communication device 10a and the fifth communication device 10e are directly received by the first to eighth communication devices 10a to 10h without being reflected by an inside of the automobile 1 or an object and radio wave intensity values in a case where reflected waves generated when the search signals transmitted from the first communication device 10a and the fifth communication device 10e are reflected and attenuated by an inside of the automobile 1 or an object are received by the first to eighth communication devices 10a to 10h), and information of signals B1 to B3 whose radio wave intensities SP when received are lower than the intensity threshold value Tp is extracted as information regarding the signals of the reflected waves due to the object, as illustrated in FIG. 10.

In the filtering process, for example, for signals received by the first to eighth communication devices 10a to 10h after the search signals are transmitted from the first communication device 10a and the fifth communication device 10e, flight distances Ds of radio waves calculated based on a time difference between the transmission time and the reception time of the search signals are compared with a predetermined flight distance threshold value Td (for example, a value determined based on an experiment performed in advance, and is set as a value between distance values from the first communication device 10a to the second to fourth communication devices 10b to 10d and distance values from the automobile 1 to objects O1 and O2 assumed to be detection targets), and information of the signals B1 to B3 whose flight distances Ds of radio waves are longer than the flight distance threshold value Td is extracted as information regarding the signals of the reflected waves due to the object, as illustrated in FIG. 10.

Then, an object detection process is executed (Sd03), so that distances between the automobile 1 and the objects present in the periphery of the automobile 1 are calculated based the information of the signals extracted by the filtering process in the step of Sd02 and the distances are output as object information Io regarding the objects to an external device (illustration omitted). When the objects are present in the periphery of the automobile 1, the external device can, for example, output a sound, an image, a video, or the like from an output unit to notify the driver that the objects are present based on the object information Io, and display the positions of the objects with respect to the automobile 1 on a display unit.

After the object detection process in the step of Sd03 is ended, the radar process Sd is ended.

As described above, in the radar process of the present embodiment, search signals are transmitted by radio waves from the first communication device 10a and the fifth communication device 10e, which operate in the networks of the second mode and the third mode, respectively, to the periphery of the automobile 1, and reflected waves generated when the search signals are reflected by an object are received by the first to eighth communication devices 10a to 10h as received signals, whereby the object is detected based on the search signals and the received signals.

In the radar process of the present embodiment, signals related to the reflected waves are extracted by the filtering process from the signals received by the first to eighth communication devices 10a to 10h. In the filtering process, signals A1 to A3 and B1 to B3 received by the first to eighth communication devices 10a to 10h are filtered so as to extract signals satisfying a predetermined criteria (for example, the radio wave intensity of a received signal is lower than the intensity threshold value Tp and a calculated distance is longer than a distance threshold value Td2), whereby the signals B1 to B3 related to the reflected waves can be extracted as illustrated in FIG. 10 for example. Here, FIG. 10 illustrates, for the received signal in the communication devices 10, a relationship of a flight time Di of radio waves between the communication devices and the object calculated based on transmission and reception times of transmitted and received signals with respect to a distribution of radio wave intensities SP of the received signals received by the communication devices 10. The horizontal axis represents the flight time Di, and the vertical axis represents the radio wave intensity SP. A1 to A3 are examples of signals directly received by the communication devices without reflection of the search signals, and B1 to B3 are examples of signals of reflected waves generated when the search signals are reflected by an object outside the automobile 1 and received by the communication devices. The intensity threshold value Tp is set to a value between radio wave intensities of signals of radio waves directly entering the second to fourth communication devices 10b to 10d from the first communication device 10a and radio wave intensities of signals of reflected waves which are reflected by an object outside the automobile 1 after the transmission from the first communication device 10a and enter the second to fourth communication devices 10b to 10d, and thus signals of radio waves directly entering the second to fourth communication devices 10b to 10d from the first communication device 10a can be filtered. The distance threshold value Td2 is set to a value greater than distances between the first communication device 10a and the second to fourth communication devices 10b to 10d, and thus signals of radio waves directly entering the second to fourth communication devices 10b to 10d from the first communication device 10a can be filtered.

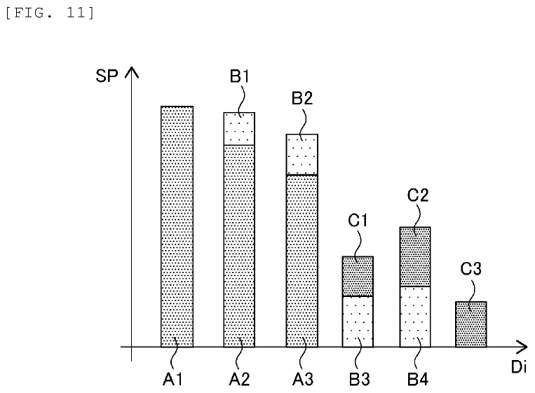

Signals received by the first to eighth communication devices 10a to 10h may include signals of reflected waves generated by reflection inside the automobile 1, and such signals related to reflected waves generated inside the automobile 1 have been reflected once or a plurality of time and largely attenuated and have longer flight times, and thus may satisfy the predetermined criteria and pass through the filtering (illustration omitted). On the other hand, for example, as illustrated in FIG. 11, in an experimental environment conducted in advance (e.g., in an anechoic chamber), for signals received by the first to the eighth communication devices 10a to 10h in a state in which reflected waves due to an object outside the automobile 1 are not received by the first to the eighth communication devices 10a to 10h (i.e., signals A1 to A3 of direct waves from the communication devices transmitting signals and signals B1 to B3 of internally-reflected waves generated by reflection inside the automobile 1), a distribution of radio wave intensities of the respective signals received is acquired and defined as a reference distribution. Then, in an actual environment, a distribution of radio wave intensities of signals received by the first to the eighth communication devices 10a to 10h (the signals A1 to A3 of the direct waves described above, the signals B1 to B3 of the internally-reflected waves, and signals C1 to C3 of externally-reflected waves due to an object outside the automobile 1) is acquired, and a difference from the reference distribution (e.g., increased portions, the signals C1 to C3 of the externally-reflected waves) is detected as being due to the reflected waves by the object outside the automobile 1. Accordingly, information regarding the reflected waves can be extracted from the signals received by the first to eighth communication devices 10a to 10h (a modification example of the filtering process).

### Effects

When a keyless entry system and a radar device, which are technologies using UWB radio waves of the related art, are installed as separate devices in the same vehicle, communication devices and control devices that transmit and receive UWB radio waves are duplicately installed, and thus the space inside the vehicle may be reduced or radio waves interfere with each other.

On the other hand, the control device for the radio wave communication system according to the present embodiment is the control device 20 for the radio wave communication system 100 mounted to the automobile 1 as a vehicle and including the first to eighth communication devices 10a to 10h that form a communication network by radio waves to communicate with the portable terminal U. The control device 20 includes the acquisition unit 20a that acquires state information regarding a state of the automobile 1, and the execution unit 20b that executes a control process of controlling the first to eighth communication devices 10a to 10h. The mode of the communication network includes the first mode PAN1 in which communication is performed between the first to eighth communication devices 10a to 10h and the portable terminal U, the second mode PAN2 and the third mode PAN3 in which communication is performed between the communication devices of the first to eighth communication devices 10a to 10h. The control process includes the locking/unlocking process Sc (communication process) of performing a control such that the first to eighth communication devices 10a to 10h communicate with the portable terminal U and the radar process Sd of performing a control such that at least one communication device (the first communication device 10a, the fifth communication device 10e) out of the first to eighth communication devices 10a to 10h emits radio waves and objects O1 and O2 located in a periphery of the automobile 1 are detected based on reflected waves generated when the radio waves are reflected by the objects. The execution unit 20b performs a control of switching the mode of the communication network based on the state information, executes the locking/unlocking process Sc (communication process) in a state in which the first mode PAN1 is formed, and executes the radar process Sd in a state in which the second mode PAN2 and the third mode PAN3 are formed.

According to such a configuration, the control device 20 can switch, based on the state information, the mode of the communication network formed by the first to eighth communication devices 10a to 10h and the portable terminal U between the first mode PAN1, the second mode PAN2, and the third mode PAN3, thereby operating the radio wave communication system 100 by switching between a radar system that detects an object using radio waves and a communication system that performs communication using radio waves in accordance with the state of the automobile 1. In the radar system or the communication system, the first to eighth communication devices 10a to 10h and the control device 20 can be used in common, and thus the installation space and the costs of the system can be reduced.

The execution unit 20b of the control device 20 of the present embodiment is configured to perform a control of switching the mode of the communication network based on the vehicle speed information Iv regarding the travel speed of the automobile 1, the seating information Ist regarding the seating state of a seat of the automobile 1, and the start information Ig regarding the start state of the power of the automobile 1 as the state information.

According to such a configuration, the execution unit 20b can operate the radio wave communication system 100 by switching between the radar system and the communication system in accordance with the state of the automobile 1.

The locking/unlocking process Sc executed by the control device 20 of the present embodiment includes the communication process in which communication is performed between the first to eighth communication devices 10a to 10h and the portable terminal U, and the locking/unlocking process Sc is configured to perform a control of locking or unlocking the lock 2 provided to the automobile 1 based on the communication result between the first to eighth communication devices 10a to 10h and the portable terminal U.

According to such a configuration, the control device 20 can communicate with the portable terminal U through the first to eighth communication devices 10a to 10h, and control the locking/unlocking device 30 to lock or unlock the lock 2 of the automobile 1 based on a locking/unlocking signal transmitted from the portable terminal U.

The radar process Sd executed by the control device 20 of the present embodiment includes the filtering process of performing filtering based on the intensity information Isp regarding the radio wave intensities of reflected waves received by the first to eighth communication devices 10a to 10h and the information of the flight distances of the reflected waves to extract signals related to the reflected waves.

According to such a configuration, the control device 20 can extract the signals due to the reflected waves from the information about the signals received by the first to eighth communication devices 10a to 10h.

A modification example of the filtering process executed by the control device 20 of the present embodiment includes a filtering in which a distribution of radio wave intensities of received signals received in a state in which reflected waves are not received by the first to the eighth communication devices 10a to 10h (e.g., an experimental environment) is acquired in advance and set as a reference value, and based on a difference between a distribution of radio wave intensities of signals actually received in a state (an actual state) in which radio waves including reflected waves are received by the first to eighth communication devices 10a to 10h and the reference value, signals related to the reflected waves are extracted.

According to such a configuration, the control device 20 can improve the accuracy in extracting the signals due to the reflected waves from the information about the signals received by the first to eighth communication devices 10a to 10h.

The portable terminal U of the present embodiment has a network coordinator function that starts network connection, and the communication device 10 includes the first communication device 10a and the fifth communication device 10e having the network coordinator function and the second communication devices 10b to 10d and the sixth communication devices 10f to 10h without the network coordinator function. The first mode PAN1 of the communication network is formed such that the first to eighth communication devices 10a to 10h are connected as end devices to a network started from the portable terminal U functioning as the network coordinator. The second mode PAN2 is formed such that the second to fourth communication devices 10b to 10d are connected as end devices to a network started from the first communication device 10a functioning as the network coordinator. The third mode PAN3 is formed such that the fourth to eighth communication devices 10f to 10h are connected as end devices to a network started from the fifth communication device 10e functioning as the network coordinator.

According to such a configuration, the control device 20 can switch the mode of the communication network from the first mode PAN1 to the second mode PAN2 and the third mode PAN3 by performing a control of switching the network coordinator from the portable terminal U to the first communication device 10a and the fifth control device 10e.

In the present embodiment, the first to third absorber 11a to 11c absorbing radio waves are disposed to a position between the first communication device 10a and the second communication device 10b, a position between the first communication device 10a and the third communication device 10c, and a position between the first communication device 10a and the fourth communication device 10d, respectively. In addition, the fourth to sixth absorbers 11d to 11f absorbing radio waves are disposed to a position between the fifth communication device 10e and the sixth communication device 10f, a position between the fifth communication device 10e and the seventh communication device 10g, and a position between the fifth communication device 10e and the eighth communication device 10h, respectively.

According to such a configuration, direct entry of radio waves transmitted from the first communication device 10a and the fifth communication device 10e to the second to fourth communication devices 10b to 10d and the sixth to eighth communication devices 10f to 10h can be reduced, and thus the accuracy in detecting reflected waves by the control device 20 can be improved.

A radio wave communication system according to the present embodiment is the radio wave communication system 100 mounted to the automobile 1 as a vehicle and including the first to eighth communication devices 10a to 10h that form a communication network by radio waves to communicate with the portable terminal U. The radio wave communication system 100 includes the acquisition unit 20a that acquires state information regarding a state of the automobile 1, and the execution unit 20b that executes a control process of controlling the first to eighth communication devices 10a to 10h. The mode of the communication network includes the first mode PAN1 in which communication is performed between the first to eighth communication devices 10a to 10h and the portable terminal U, the second mode PAN2 and the third mode PAN3 in which communication is performed between the communication devices of the first to eighth communication devices 10a to 10h. The control process includes the locking/unlocking process Sc (communication process) of performing a control such that the first to eighth communication devices 10a to 10h communicate with the portable terminal U and the radar process Sd of performing a control such that at least one communication device (the first communication device 10a, the fifth communication device 10e) out of the first to eighth communication devices 10a to 10h emits radio waves and objects O1 and O2 located in a periphery of the automobile 1 are detected based on reflected waves generated when the radio waves are reflected by the objects. The execution unit 20b performs a control of switching the mode of the communication network based on the state information, executes the locking/unlocking process Sc (communication process) in a state in which the first mode PAN1 is formed, and executes the radar process Sd in a state in which the second mode PAN2 and the third mode PAN3 are formed.

According to such a configuration, the radio wave communication system 100 can switch, based on the state information, the mode of the communication network formed by the first to eighth communication devices 10a to 10h and the portable terminal U between the first mode PAN1, the second mode PAN2, and the third mode PAN3, thereby operating the radio wave communication system 100 by switching between a radar system that detects the object using radio waves and a communication system that performs communication using radio waves in accordance with the state of the automobile 1. In the radar system and the communication system, the first to eighth communication devices 10a to 10h and the control device 20 can be used in common, and thus the installation space and the costs of the system can be reduced.

A control method for a radio wave communication system according to the present embodiment is a control method for the radio wave communication system 100 mounted to the automobile 1 as a vehicle and including the first to eighth communication devices 10a to 10h that forms a communication network by radio waves to communicate with a portable terminal U. The control method includes an acquisition step of acquiring state information regarding a state of the automobile 1 by an acquisition unit 20a, and an execution step of executing a control process of controlling the first to eighth communication devices 10a to 10h by an execution unit 20b. The mode of the communication network includes the first mode PAN1 in which communication is performed between the first to eighth communication devices 10a to 10h and the portable terminal U, and the second mode PAN2 and the third mode PAN3 in which communication is performed between the communication devices of the first to eighth communication devices 10a to 10h. The control process includes the locking/unlocking process Sc (communication process) of performing a control such that the first to eighth communication devices 10a to 10h communicate with the portable terminal U and the radar process Sd of performing a control such that at least one communication device (the first communication device 10a, the fifth communication device 10e) out of the first to eighth communication devices 10a to 10h emits radio waves and objects O1 and O2 located in a periphery of the automobile 1 are detected based on reflected waves generated when the radio waves are reflected by the objects. In the execution step, the execution unit 20b performs a control of switching the mode of the communication network based on the state information, executes the locking/unlocking process Sc (communication process) in a state in which the first mode PANI is formed, and executes the radar process Sd in a state in which the second mode PAN2 and the third mode PAN3 are formed.

According to such a configuration, based on the state information, the mode of the communication network formed by the first to eighth communication devices 10a to 10h and the portable terminal U is switched between the first mode PAN1, the second mode PAN2, and the third mode PAN3, whereby the radio wave communication system 100 can be operated by being switched between a radar system that detects an object using radio waves and a communication system that performs communication using radio waves in accordance with the state of the automobile 1.

The examples of the embodiment of the invention have been described above, but the invention is not limited to these examples of the embodiment, and it is obvious that changes and additions without departing from the gist of the invention are included in the invention.

1. A control device for a radio wave communication system mounted to a vehicle and including a plurality of communication devices that form a communication network by radio waves to communicate with a portable terminal, the control device configured:
to acquire state information regarding a state of the vehicle; and
execution unit configured to execute a control process of controlling the plurality of communication devices,
the communication network having a mode, the mode including
a first mode in which communication is performed between the plurality of communication devices and the portable terminal, and
a second mode in which communication is performed between the plurality of communication devices,
the control process including
a communication process of performing a control such that the plurality of communication devices communicates with the portable terminal, and
a radar process of performing a control such that at least one communication device out of the plurality of communication devices emits radio waves and an object located in a periphery of the vehicle is detected based on reflected waves generated when the radio waves are reflected by the object, and
the execution unit performing a control of switching the mode of the communication network based on the state information, executing the communication process in a state in which the first mode is formed, and executing the radar process in a state in which the second mode is formed.

2. The control device according to claim 1, wherein the execution unit performs the control of switching the mode of the communication network based on information regarding at least any one of information on a travel speed of the vehicle, information on a seating state of a seat of the vehicle, or information on a start state of a power of the vehicle, as the state information.

3. The control device according to claim 1, wherein, in the communication process, a control of locking or unlocking a lock provided to the vehicle is performed based on communication result between the plurality of communication devices and the portable terminal.

4. The control device according to claim 1, wherein, in the radar process, a control of detecting the object is performed based on at least one of information on radio wave intensities of the reflected waves received or information on flight distances of the reflected waves.

5. The control device according to claim 1, wherein, in the radar process, a control of detecting the object is performed based on a difference between a reference value based on a distribution of radio wave intensities received in a state in which the reflected waves are not received by the plurality of communication devices and a distribution of radio wave intensities received in a state in which the radio waves including the reflected waves are received by the plurality of communication devices.

6. The control device according to claim 1, wherein the portable terminal has a function of a network coordinator that starts network connection,
the plurality of communication devices includes a first communication device having the function of the network coordinator and a second communication device without the function of the network coordinator
the first mode is formed such that the plurality of communication devices are connected as end devices to a network started from the portable terminal functioning as the network coordinator, and
the second mode is formed such that the second communication device is connected as an end device to a network started from the first communication device functioning as the network coordinator.

7. The control device according to claim 6, wherein an absorber that absorbs the radio waves is located at a position between the first communication device and the second communication device.

8. A radio wave communication system mounted to a vehicle and including a plurality of communication devices that forms a communication network by radio waves to communicate with a portable terminal, the radio wave communication system comprising:
an acquisition unit configured to acquire state information regarding a state of the vehicle; and
an execution unit configured to execute a control process of controlling the plurality of communication devices,
the communication network having a mode, the mode including
a first mode in which communication is performed between the plurality of communication devices and the portable terminal, and
a second mode in which communication is performed between the plurality of communication devices,
the control process including
a communication process of performing a control such that the plurality of communication devices communicates with the portable terminal, and
a radar process of performing a control such that at least one communication device out of the plurality of communication devices emits radio waves and an object located in a periphery of the vehicle is detected based on reflected waves generated when the radio waves are reflected by the object, and
the execution unit performing a control of switching the mode of the communication network based on the state information, executing the communication process in a state in which the first mode is formed, and executing the radar process in a state in which the second mode is formed.

9. A control method for a radio wave communication system mounted to a vehicle and including a plurality of communication devices that forms a communication network by radio waves to communicate with a portable terminal, the control method comprising:
an acquisition step of acquiring state information regarding a state of the vehicle by an acquisition unit; and
an execution step of executing a control process of controlling the plurality of communication devices by an execution unit,
the communication network having a mode, the mode including
a first mode in which communication is performed between the plurality of communication devices and the portable terminal, and
a second mode in which communication is performed between the plurality of communication devices,
the control process including
a communication process of performing a control such that the plurality of communication devices communicates with the portable terminal, and
a radar process of performing a control such that at least one communication device out of the plurality of communication devices emits radio waves and an object located in a periphery of the automobile is detected based on reflected waves generated when the radio waves are reflected by the object, and
in the execution step, the execution unit performing a control of switching the mode of the communication network based on the state information, executing the communication process in a state in which the first mode is formed, and executing the radar process in a state in which the second mode is formed.
